(19) United States
(12) Patent Application Publication
(10) Pub. No.: US 2015/0189128 A1
(43) Pub. Date: Jul. 2, 2015

(54) SYNCHRONIZATION OF VIDEO BASED ON CLOCK ADJUSTMENT

(71) Applicant: Nathaniel D. Naegle, Pleasanton, CA (US)

(72) Inventor: Nathaniel D. Naegle, Pleasanton, CA (US)

(21) Appl. No.: 14/142,205

(22) Filed: Dec. 27, 2013

(51) Int. Cl. H04N 5/06

(52) U.S. Cl. CPC H04N 5/06

(57) ABSTRACT

In embodiments, apparatuses, methods and storage media are described that are associated with synchronization of video during presentation. Video frames may be received by a computing device for display. A clock of a computing device may be used to control display of the frames as they are received. The clock may include a spread-spectrum clock. A clock control module may be configured to control a clock rate for the clock based on a comparison of times when frames of video are received and when frames of video are displayed. The clock control module may be configured to make adjustment calls to the clock of the computing device based on differences between the receipt times and the display times. The use of low-pass filtered differences being used as input into the clock control module may constitute a phase-locked loop. Other embodiments may be described and claimed.

### TECHNICAL FIELD

The present disclosure relates to the field of data processing, in particular, to apparatuses, methods and systems associated with presentation of video.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Video is frequently displayed through coupling of video sources to display devices. Oftentimes, however, these video sources and display devices may be configured to process video at different rates. For example a rate at which frames of video are received from a video source may not be the same as a rate at which the display device is configured to display the received frames. When such a mismatch occurs, frames may be dropped (such as when the display rate is comparatively lower than the receipt rate) or repeated (such as when the display rate is comparatively higher than the receipt rate. This dropping or repeating of frames can be noticeable to a viewer as skipping or stuttering, reducing the perceived quality of the displayed video.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example arrangement for content distribution and consumption, in accordance with various embodiments.

FIG. 2 illustrates an example arrangement of various entities associated with adjustment of a clock rate for synchronization of video, in accordance with various embodiments.

FIG. 3 illustrates an example process for presentation of video, in accordance with various embodiments.

FIG. 4 illustrates an example process for adjustment of a clock rate for presentation of video, in accordance with various embodiments.

FIG. 5 illustrates an example computing environment suitable for practicing various aspects of the present disclosure, in accordance with various embodiments.

FIG. 6 illustrates an example storage medium with instructions configured to enable an apparatus to practice various aspects of the present disclosure, in accordance with various embodiments.

### DETAILED DESCRIPTION

Embodiments described herein are directed to, for example, methods, computer-readable media, and apparatuses associated with synchronization of video during presentation. In various embodiments, video frames may be received by a computing device for display. A clock of a computing device may be used to control display of the frames as they are received. In various embodiments, the clock may include, for example, a spread-spectrum clock. In various embodiments, the spread-spectrum clock may be included in a system-on-a-chip configuration, as described below. In various embodiments, a clock control module may be configured to adjust a clock rate for the clock to control display of the received frames of video. In various embodiments, the clock control module may be configured to control the clock rate based on a comparison of times when frames of video are received and when frames of video are displayed. In various embodiments, these times may be based on a system time, such as received from a system clock of the computing device. In various embodiments, the clock control module may be configured to make adjustment calls to the clock of the computing device used to control display of the frames based on differences between the receipt times and the display times. In various embodiments, these differences may be passed through a low-pass filter prior to be used as input into clock control module. In various embodiments, the use of low-pass filtered differences being used as input into the clock control module may constitute a phase-locked loop. Through adjustment of the clock, the computing device may be able to operate the clock simultaneously both to provide a spread-spectrum clock as to provide a phase-locked loop for synchronization of video. Other embodiments may be described and claimed.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

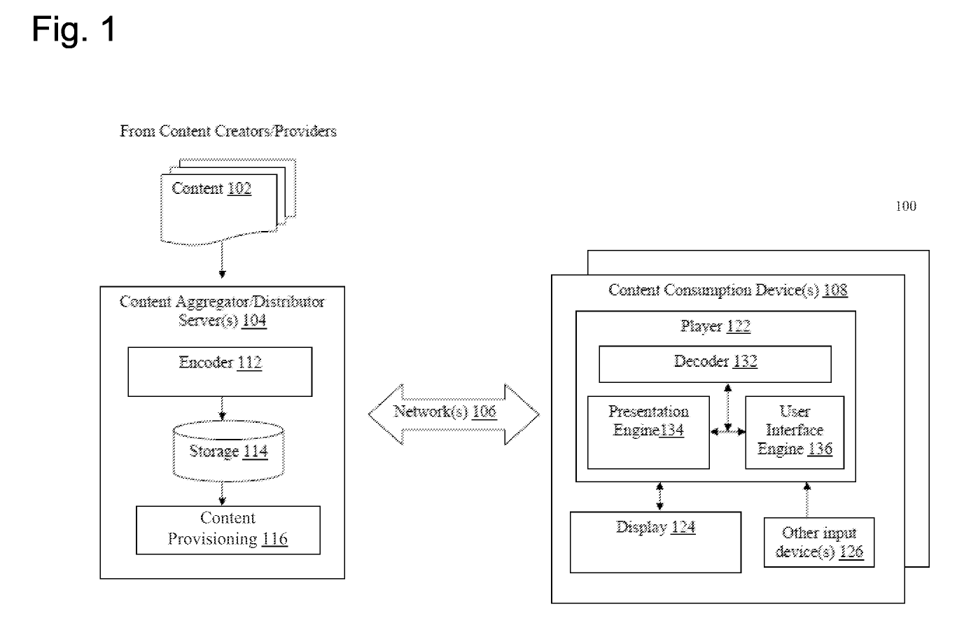

Referring now to FIG. 1, an arrangement 100 for content distribution and consumption, in accordance with various embodiments, is illustrated. As shown, in embodiments, arrangement 100 for distribution and consumption of content may include a number of content consumption devices 108 coupled with one or more content aggregator/distributor servers 104 via one or more networks 106. Content aggregator/distributor servers 104 may be configured to aggregate and distribute content to content consumption devices 108 for consumption, e.g., via one or more networks 106. In various embodiments, content presentation techniques described herein may be implemented in association with arrangement 100. In other embodiments, different arrangements, devices, and/or systems maybe used.

In embodiments, as shown, content aggregator/distributor servers 104 may include encoder 112, storage 114 and content provisioning 116, which may be coupled to each other as shown. Encoder 112 may be configured to encode content 102 from various content creators and/or providers 101, and storage 114 may be configured to store encoded content. Content provisioning 116 may be configured to selectively retrieve and provide encoded content to the various content consumption devices 108 in response to requests from the various content consumption devices 108. Content 102 may be media content of various types, having video, audio, and/or closed captions, from a variety of content creators and/or providers. Examples of content may include, but are not limited to, movies, TV programming, user created content (such as YouTube video, iReporter video), music albums/titles/pieces, and so forth. Examples of content creators and/or providers may include, but are not limited to, movie studios/distributors, television programmers, television broadcasters, satellite programming broadcasters, cable operators, online users, and so forth.

In various embodiments, for efficiency of operation, encoder 112 may be configured to encode the various content 102, typically in different encoding formats, into a subset of one or more common encoding formats. However, encoder 112 may be configured to nonetheless maintain indices or cross-references to the corresponding content in their original encoding formats. Similarly, for flexibility of operation, encoder 112 may encode or otherwise process each or selected ones of content 102 into multiple versions of different quality levels. The different versions may provide different resolutions, different bitrates, and/or different frame rates for transmission and/or playing. In various embodiments, the encoder 112 may publish, or otherwise make available, information on the available different resolutions, different bitrates, and/or different frame rates. For example, the encoder 112 may publish bitrates at which it may provide video or audio content to the content consumption device(s) 108. Encoding of audio data may be performed in accordance with, e.g., but are not limited to, the MP3 standard, promulgated by the Moving Picture Experts Group (MPEG). Encoding of video data may be performed in accordance with, e.g., but are not limited to, the H264 standard, promulgated by the International Telecommunication Unit (ITU) Video Coding Experts Group (VCEG). Encoder 112 may include one or more computing devices configured to perform content portioning, encoding, and/or transcoding, such as described herein.

Storage 114 may be temporal and/or persistent storage of any type, including, but are not limited to, volatile and non-volatile memory, optical, magnetic and/or solid state mass storage, and so forth. Volatile memory may include, but are not limited to, static and/or dynamic random access memory. Non-volatile memory may include, but are not limited to, electrically erasable programmable read-only memory, phase change memory, resistive memory, and so forth.

In various embodiments, content provisioning 116 may be configured to provide encoded content as discrete files, portions of files, and/or as continuous streams of encoded content. Content provisioning 116 may be configured to transmit the encoded audio/video data (and closed captions, if provided) in accordance with any one of a number of streaming and/or transmission protocols. The streaming protocols may include, but are not limited to, the Real-Time Streaming Protocol (RTSP). Transmission protocols may include, but are not limited to, the transmission control protocol (TCP), user datagram protocol (UDP), and so forth. In various embodiments, content provisioning 116 may be configured to provide media files that are packaged according to one or more output packaging formats.

In various embodiments, content aggregator/distributor servers 104 may not include the encoder 112 but may still include the storage 114 and/or the content provisioning 116. In various embodiments, the content aggregator/distributor servers 104 may include one more servers which may be separately addressable and/or may be configured to separately provide encoded content.

Networks 106 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the content distribution end, networks 106 may include one or more local area networks with gateways and firewalls, through which content aggregator/distributor server 104 communicate with content consumption devices 108. Similarly, at the content consumption end, networks 106 may include base stations and/or access points, through which consumption devices 108 communicate with content aggregator/distributor server 104. In between the two ends may be any number of network routers, switches and other networking equipment of the like. However, for ease of understanding, these gateways, firewalls, routers, switches, base stations, access points and the like are not shown.

In various embodiments, as shown, a content consumption device 108 may include player 122, display 124 and user input device(s) 126. Player 122 may be configured to receive streamed content, decode and recover the content from the content stream, and present the recovered content on display 124, in response to user selections/inputs from user input device(s) 126. In various embodiments, the player 122 may be configured to present unencoded content as well. In various embodiments, such content may include content sent by a device other than the content aggregator/distributor servers 104, such as a media player device or a camera device.

In various embodiments, player 122 may include decoder 132, presentation engine 134 (“PE 134”) and user interface engine 136. Decoder 132 may be configured to receive streamed content, decode and recover the content from the content stream. PE 134 may be configured to present the recovered content on display 124, in response to user selections/inputs. In various embodiments, decoder 132 and/or PE 134 may be configured to present audio and/or video content to a user that has been encoded using varying encoding control variable settings in a substantially seamless manner. Thus, in various embodiments, the decoder 132 and/or PE 134 may be configured to present two portions of content that vary in resolution, frame rate, and/or compression settings without interrupting presentation of the content. User interface engine 136 may be configured to receive signals from user input device 126 that are indicative of the user selections/inputs from a user, and to selectively render a contextual information interface as described herein. PE 134 may also be configured to receive and present unencoded content, such as directly transmitted video from a camera or other device. In some embodiments, PE 134 may be configured to present the content without controlling a rate at which the content is pushed to the content consumption device 108. Techniques described herein may facilitate synchronization of a rate of display of the content with a rate at which the content is pushed from the camera or other device.

While shown as part of a content consumption device 108, display 124 and/or user input device(s) 126 may be stand-alone devices or integrated, for different embodiments of content consumption devices 108. For example, for a television arrangement, display 124 may be a stand alone television set, Liquid Crystal Display (LCD), Plasma and the like, while player 122 may be part of a separate set-top set, and user input device 126 may be a separate remote control (such as described below), gaming controller, keyboard, or another similar device. Similarly, for a desktop computer arrangement, player 122, display 124 and user input device(s) 126 may all be separate stand alone units. On the other hand, for a tablet arrangement, display 124 may be a touch sensitive display screen that includes user input device(s) 126, and player 122 may be a computing platform with a soft keyboard that also includes one of the user input device(s) 126. Further, display 124 and player 122 may be integrated within a single form factor. Similarly, for a smartphone arrangement, player 122, display 124 and user input device(s) 126 may be likewise integrated.

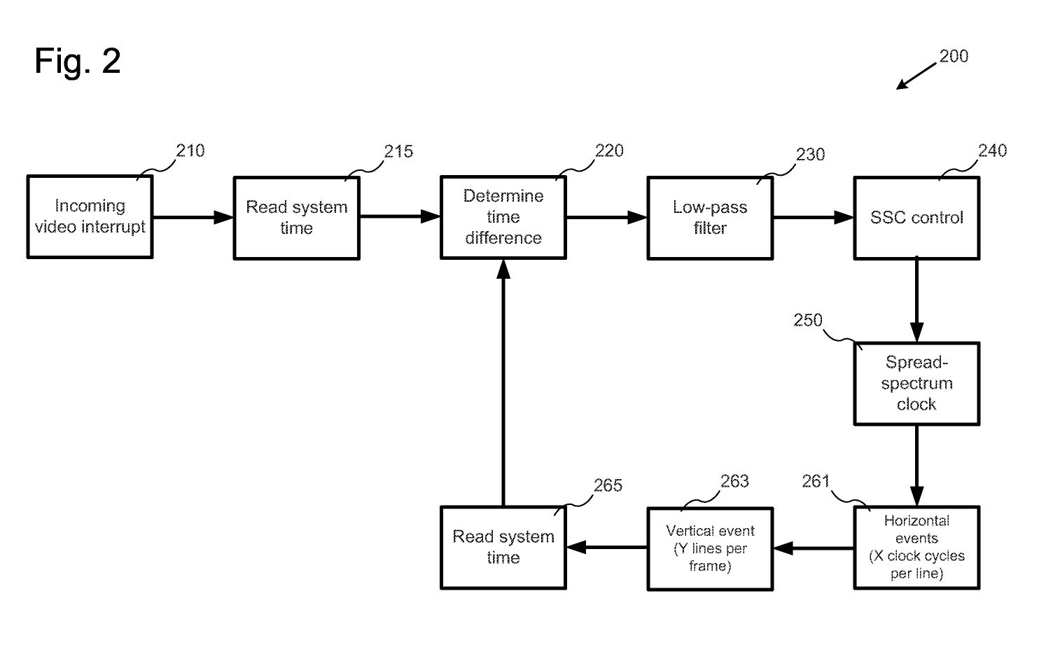

Referring now to FIG. 2, an example arrangement 200 of various entities associated with adjustment of a clock rate for synchronization of video are illustrated, in accordance with various embodiments. While particular modules and data flow are illustrated in FIG. 2, it may be recognized that, in various embodiments, modules and data may be merged, divided further, and/or omitted entirely. In various embodiments, various modules of arrangement 200 may be implemented in hardware, software, or in a combination of hardware and software. In various embodiments, one or more portions of arrangement 200 may be implemented as part of the content consumption device 108. It may be noted that, while various modules and data flows associated with synchronization of video are illustrated in FIG. 2, for the sake of easy illustration, some video elements are not illustrated. For example, entities involved in the actual receipt, transmission, and display of video are not illustrated in the Figure.

In various embodiments, a video display module 260 of arrangement 200 may configured to display frames of video received from a video source (not illustrated). In various embodiments, the video source may include a video camera, a physical media player, such as a DVD or Blu-ray™, a streaming or stored media player, a gaming system, as well as other video sources. The video display module 260 may be through of, in various embodiments, as being “pushed” frames of video from the video source for display.

In various embodiments, the video display module may be configured to display frames of video according to a clock rate of a clock, such as spread-spectrum clock 250 (“SSC 250”). In various embodiments, the SSC 250 may provide a substantively regular clock cycle signal to the video display module 260, as may be understood. The video display module 260 may, in turn, display received frames of video according to the clock rate of the SSC 250. In various embodiments, the video display module may be configured to perform a horizontal event 261, such as indicating completion of drawing of a horizontal line of a video frame on display 124 after a pre-determined number of clock cycles have been received from the SSC 250. In various embodiments, the video display module may be configured to perform a vertical event 263, such as indication of completing of drawing of a video frame on display 124 after a pre-determined number of horizontal events 261 have occurred. In other embodiments drawings of video frames may be timed based on a total number of clock cycles of the SSC 250, rather than a combination of horizontal and vertical events. In various embodiments, disparity between the rate at which frames are “pushed” to the video display module 260 and the rate at which the video display module 260 displays the frames may cause a need for dropping or repeating of frames, causing video artifacts. Techniques described herein may alleviate or eliminate these phase-based artifacts by controlling the display rate using the SSC 250 to operate a phase-locked loop for display control.

In various embodiments, an SSC control module 240 (“SCM 240”) may be configured to adjust a clock rate of the SSC 250 in order to adjust display of frames of video by the display module 260. In various embodiments, the SCM 240 may be configured to adjust the clock rate based on differences between a rate of receipt of frames of videos from the video source (a “receipt rate”) and a rate of display of the frames (a “display rate”), the display rate being based on the clock rate of the SSC 250. In various embodiments, the SCM 240 may be configured to determine these rates and make adjustments to the SSC 250 based on times at which frames of video are received (“receipt times”) as well as times at which frames of video are displayed (“display times”). In various embodiments, the SCM 240 may be configured to operate in accordance with known phase-locked loop techniques. In various embodiments, differences in times may be determined by reading a system time, such as by reading a time of a system clock of the content consumption device 108. It may be noted that, in various embodiments, the system time of the may be read at a finer granularity (i.e. at a higher rate) than that the rate of receipt of the frames of video, which may better allow for adjustment based on changes in system time differences.

Thus, for example, at module 265, the system time may be read at every vertical event 263. This time may be associated with display of a frame and thus may be referred to as a “display time.” Similarly, at module 210, an incoming frame interrupt signal maybe received every time a frame of video is received from a video source, and at module 215, a system time may be read for that incoming frame interrupt, which may be referred to as a “receipt time.”

In various embodiments, a module 220 may be configured to compute a difference between a receipt time and a display time. In various embodiments, the module 220 may be configured to compute a difference between a receipt time and a display time for a same frame of video. In such embodiments, the difference computed may be considered to be a transit time between receipt and display of a frame of video. In other embodiments, the receipt time and display time used for the computation of a difference may not be associated with a same frame of video. However, it may be noted that these differences may nonetheless be used for adjustment of the SSC 250, as changes in the differences from frame to frame may, in various embodiments, be indicative of a mismatch between the receipt rate and the display rate, and therefore used for adjustment of the clock rate of SSC 250. In various embodiments, low-pass filter 230 may operate on the difference determined by module 220 to perform a low-pass filtering, and to therefore remove high-frequency information from the computed differences. By performing low-pass filtering, the arrangement 200 may be configured to filter out noise in the determined differences, thereby ignoring minor changes to the differences computed by module 220 and adjust the SSC 250 only when the determined differences are significant.

In various embodiments, high-frequency variations which may be typical of the SSC 250 when operating as a spread-spectrum clock may fall above the cut-off frequency of the low-pass filter 230. Thus, these high-frequency variations may be rejected by the filter. In some embodiments, spread-spectrum high-frequency variations may be averaged to zero in the horizontal event 261 and vertical event 263, and may not show up as variations at phase detector 220. As such, in various embodiments, thus, the SSC 250 may be simultaneously operated to perform a traditional spread-spectrum function, as well as a phase-locked loop function, since the spread-spectrum variations may average to zero and have no effect on phase-locked loop operations.

Significantly, one need not choose to operate SSC 250 as either a spread-spectrum clock or a numerically controlled clock oscillator of a phase-locked loop; one can combine these functions with no changes to the SSC hardware. It is entirely embodied in the software control of the SSC. One simply sums (in software) the high frequency variations for spread-spectrum operation, with the low-frequency variations determined by the PLL phase detector, which in this embodiment, is the software-based determination of system time differences being described here. In various embodiments, different filters may be used.

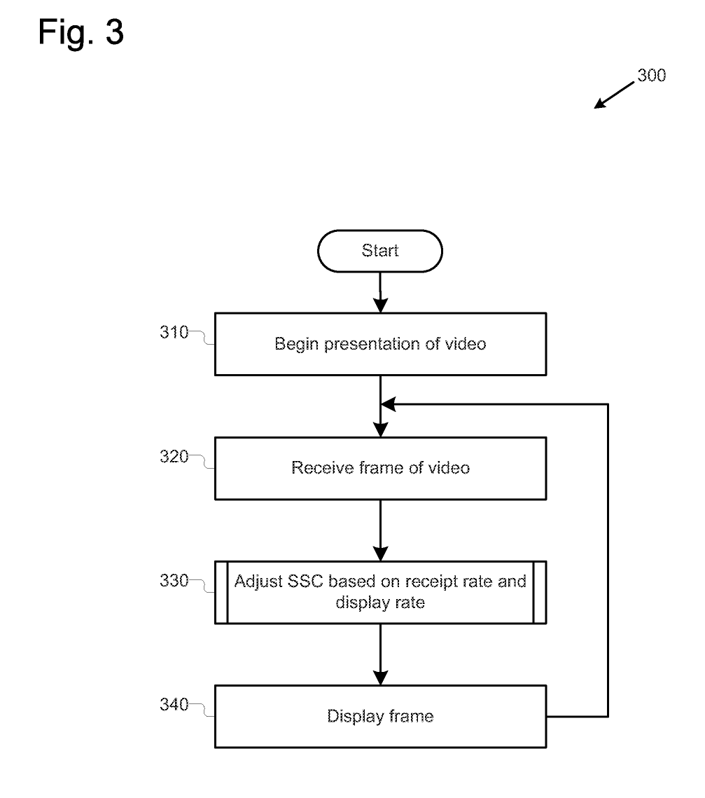

Referring now to FIG. 3, examples of operation of the SSC 250 are illustrated in accordance with various embodiments. In various embodiments, a spread-spectrum clock, such as SSC 250 may include an oscillating clock where signals are output at multiple gradations around a central signal frequency 300. Thus, at any particular time a signal may be output via a particular frequency within a pre-determined range around the central signal frequency 300. In some embodiments, the SSC 250 may be configured to operate with a range of +−0.25% around a central signal frequency 300. These signals may be oscillated back and forth over this frequency range on a periodic basis, creating a periodic signal as they pass over the central frequency. Through the use of such signal-spreading techniques, the SSC 250 may operate to cause PE 134 to output less electromagnetic interference (EMI) than if it operated only on a single frequency, thereby lessening possible interfering output by the SSC 250.

Referring now to FIG. 3, an example process 300 for presentation of video is illustrated in accordance with various embodiments. While FIG. 3 illustrates particular example operations for process 300, in various embodiments, process 300 may include additional operations, omit illustrated operations, and/or combine illustrated operations. In various embodiments, operations of process 300 may be performed by the arrangement 200 of the content consumption device 108.

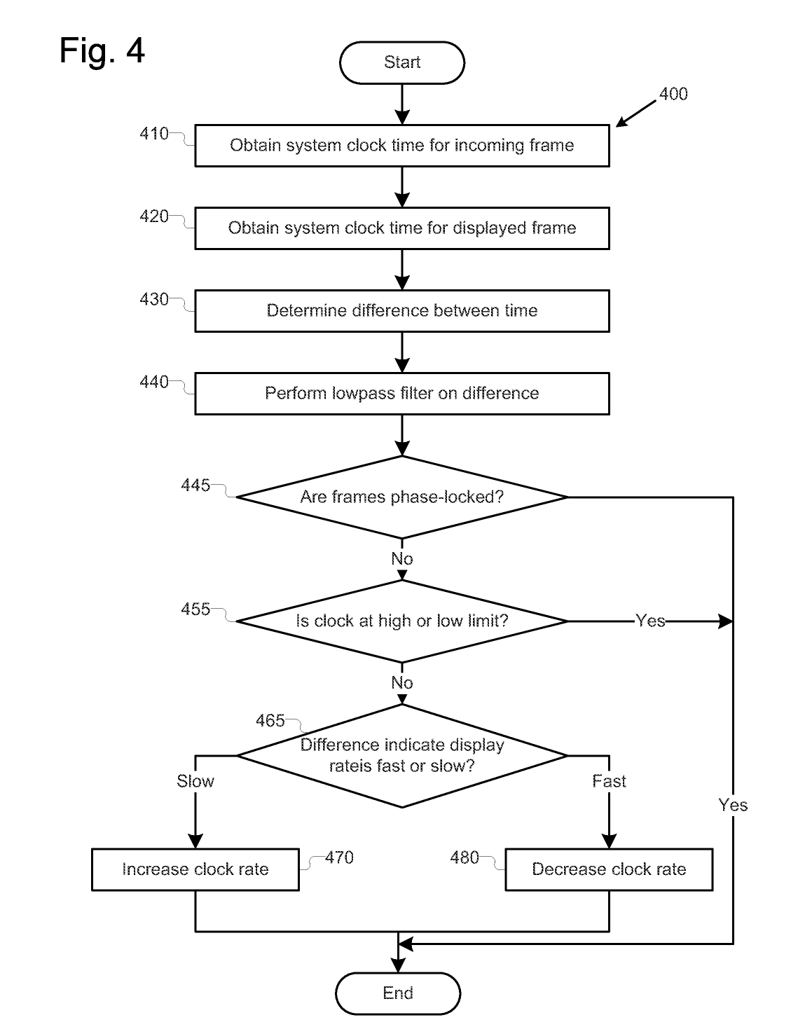

The process may begin at operation 310, where presentation of video may begin. As discussed earlier, the video may be received from a video source, such as an external device or process that outputs frames of video. At operation 320, the content consumption device 108 may receive a frame of video from the video source. In various embodiments, this receipt may be accompanied by an incoming frame interrupt signal at module 210, which may be used to determine a receipt time as described herein. Next, at operation 330, the SCM 240 may adjust the clock rate of the SSC 250 based on the frame receipt rate and the display rate. Particular embodiments, and implementation details of operation 330 are described below with reference to process 400 of FIG. 4. Next, at operation 340, the received frame may be displayed and the process may be repeated for the next frame at operation 320. It may be noted that, in various embodiments, the adjustment of the clock rate may not necessarily occur between receipt of a frame and display of that frame; the order presented in process 300 is merely done for sake of simple illustration. In various embodiments, the process of adjusting the clock rate may thus be done independently of actual display of the received frames.

Referring now to FIG. 4, an example process 400 for adjustment of a clock rate for display of video is illustrated in accordance with various embodiments. While FIG. 4 illustrates particular example operations for process 400, in various embodiments, process 400 may include additional operations, omit illustrated operations, and/or combine illustrated operations. In various embodiments, process 400 may be performed to implement operation 330 of process 300 of FIG. 3. In various embodiments, process 400 may be performed by various modules of assembly 200 of the content consumption device 108.

The process may begin at operation 410, where the module 215 may obtain a system time for an incoming frame (“frame time”). Next, at operation 420, the module 265 may obtain a system time for a displayed frame (“display time”). Next, at operation 430, the module 220 may determine a difference in the two times, and at operation 440 the low-pass filter 240 may perform a low-pass filter on the difference.

After performance of the operations 410-440, the resulting value may be a low-noise time difference value. This value may be used by the SCM 240 to determine, at decision operation 445, whether the arrangement 200 is in a phase-locked loop, as may be understood according to known techniques. If the arrangement is phase-locked, then the process may end. If not, then at decision operation 455 the SCM 240 may determine whether the SSC 250 is at a high or low limit of its operation. For example, if the SSC 250 is operating at its highest limit, it may not be able to be adjusted any further. Therefore, in various embodiments, if the SSC 250 is at a high or low limit, then the process may end. In some embodiments, the SCM 240 may cease or pause further adjustment of the SSC after ending process 400.

If however, the SSC 250 is not at a high or low limit, then the SCM 240 may determine whether the clock rate of the SSC 250 needs to be adjusted up or down. Thus, at decision operation 465, the SCM 240 may determine if the display rate is fast or slow as compared to the receipt rate. In various embodiments, the SCM 240 may determine that the display rate is slow if the values of the differences are increasing from frame to frame (assuming that the display time is subtracted from the receipt time). Similarly, using the same order of subtracting display times from receipt times, if the differences are decreasing from frame to frame, the SCM 240 may determine at decision operation 465 that the display rate is fast compared to the receipt rate. Conversely, if the order used in the difference determination at operation 430 is reversed, then the SCM 240 may likewise make opposite determinations based on increasing or decreasing differences.

In either event, if the SCM 240 determines at decision operation 465 that the display rate is slow, then at operation 470 the SCM 240 may increase the clock rate of the SSC 250. In various embodiments, the SCM 240 may be configured to increase the clock rate by performing a call, such as a hardware call, in the case that the SCM 240 is implemented in hardware (such as on a system-on-a-chip configuration). If the SCM 240 determines at decision operation 465 that the display rate is fast, then at operation 480 the SCM 240 may likewise decrease the clock rate of the SSC 250. It may be noted that, in some embodiments, the SCM 240 may perform a determination of whether the SSC 250 is at a high or low limit after determining whether the display rate is fast or slow and before adjusting the clock rate, such that it may only have to determine a single limit of the SSC 250. In either event, the process may then end.

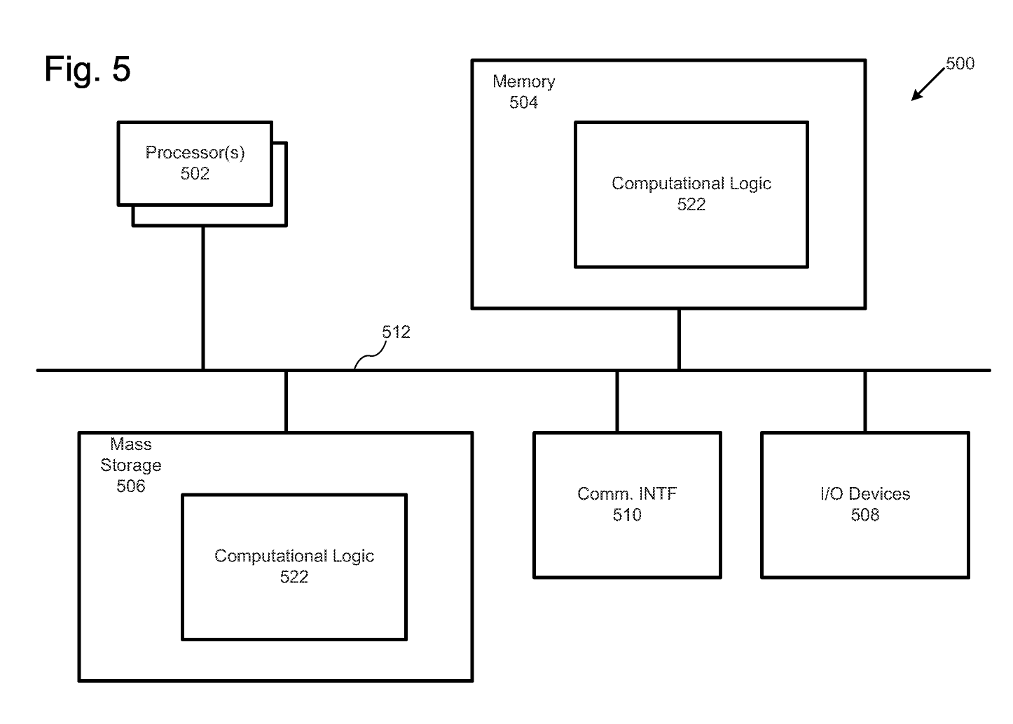

Referring now to FIG. 5, an example computer suitable for practicing various aspects of the present disclosure, including processes of FIGS. 3 and 4, is illustrated in accordance with various embodiments. As shown, computer 500 may include one or more processors or processor cores 502, and system memory 504. For the purpose of this application, including the claims, the terms “processor” and “processor cores” may be considered synonymous, unless the context clearly requires otherwise. Additionally, computer 500 may include mass storage devices 506 (such as diskette, hard drive, compact disc read only memory (CD-ROM) and so forth), input/output devices 508 (such as display, keyboard, cursor control, remote control, gaming controller, image capture device, video input devices such as MIPI-CSI, and so forth) and communication interfaces 510 (such as network interface cards, modems, infrared receivers, radio receivers (e.g., Bluetooth), and so forth). The elements may be coupled to each other via system bus 512, which may represent one or more buses. In the case of multiple buses, they may be bridged by one or more bus bridges (not shown).

Each of these elements may perform its conventional functions known in the art. In particular, system memory 504 and mass storage devices 506 may be employed to store a working copy and a permanent copy of the programming instructions implementing the operations associated with content consumption device 108, e.g., operations associated with presentation of video such as shown in FIGS. 3 and 4. The various elements may be implemented by assembler instructions supported by processor(s) 502 or high-level languages, such as, for example, C, that can be compiled into such instructions.

The permanent copy of the programming instructions may be placed into permanent storage devices 506 in the factory, or in the field, through, for example, a distribution medium (not shown), such as a compact disc (CD), or through communication interface 510 (from a distribution server (not shown)). That is, one or more distribution media having an implementation of the agent program may be employed to distribute the agent and program various computing devices.

The number, capability and/or capacity of these elements 510-512 may vary, depending on whether computer 500 is used as a content aggregator/distributor server 104 or a content consumption device 108 (e.g., a player 122). Their constitutions are otherwise known, and accordingly will not be further described.

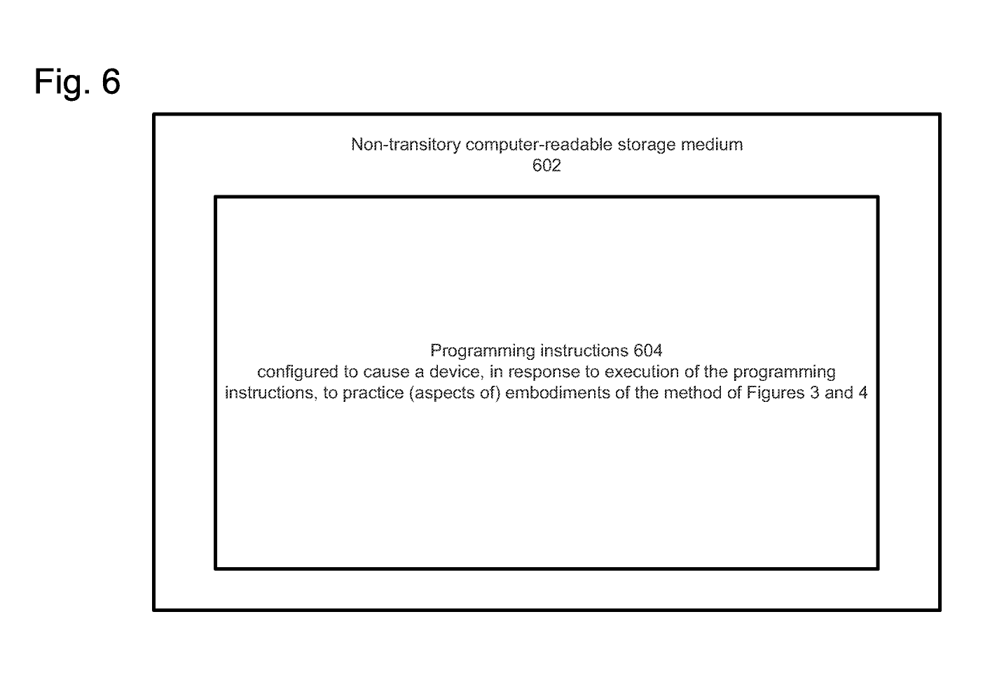

FIG. 6 illustrates an example least one computer-readable storage medium 602 having instructions configured to practice all or selected ones of the operations associated with content consumption device 108, e.g., operations associated with presentation of video, earlier described, in accordance with various embodiments. As illustrated, least one computer-readable storage medium 602 may include a number of programming instructions 604. Programming instructions 604 may be configured to enable a device, e.g., computer 500, in response to execution of the programming instructions, to perform, e.g., various operations of processes of FIGS. 4 and 5, e.g., but not limited to, to the various operations performed to perform presentation of video. In alternate embodiments, programming instructions 604 may be disposed on multiple least one computer-readable storage media 602 instead.

Referring back to FIG. 5, for one embodiment, at least one of processors 502 may be packaged together with computational logic 522 configured to practice aspects of processes of FIGS. 3 and 4. For one embodiment, at least one of processors 502 may be packaged together with computational logic 522 configured to practice aspects of processes of FIGS. 3 and 4 to form a System in Package (SiP). For one embodiment, at least one of processors 502 may be integrated on the same die with computational logic 522 configured to practice aspects of processes of FIGS. 3 and 4. For one embodiment, at least one of processors 502 may be packaged together with computational logic 522 configured to practice aspects of processes of FIGS. 3 and 4 to form a System on Chip (SoC). For at least one embodiment, the SoC may be utilized in, e.g., but not limited to, a computing tablet. In various embodiments, the SoC may include the SSC 250 implemented in hardware, and may be configured to accept one or more calls to the hardware, such as by the SCM 240 running in software or hardware, to modify the clock rate of the SSC 250.

Various embodiments of the present disclosure have been described. These embodiments include, but are not limited to, those described in the following paragraphs.

Example 1 includes one or more computer-readable storage media including a plurality of instructions to cause a computing device, in response to execution of the instructions by the computing device to facilitate presentation of synchronized video by causing the computing device to receive frames of video for display by the computing device and, during display of the video, adjust a clock rate for a clock of the computing device used to control display of the video to synchronize display of the video with receipt of the frames of video.

Example 2 includes the one or more computer-readable media of example 1, wherein the clock includes an oscillating clock and wherein adjust the clock rate includes adjust a rate of oscillation of the clock.

Example 3 includes the one or more computer-readable media of example 2, wherein the clock includes a spread-spectrum clock having a frequency range and to provide spread-spectrum clock functions in addition to controlling display of the video, and wherein adjust the rate of oscillation includes adjust the rate of oscillation of the spread-spectrum clock over its frequency range.

Example 4 includes the one or more computer-readable media of example 3, wherein the spread-spectrum clock is implemented in hardware and adjust the rate of oscillation of the spread-spectrum clock includes perform one or more software calls to set frequency control values in the hardware for the spread-spectrum clock.

Example 5 includes the one or more computer-readable media of any of examples 1-4, wherein adjust the clock rate for the clock includes adjust the clock rate based on times of display of the frames of video.

Example 6 includes the one or more computer-readable media of example 5, wherein adjust the clock rate based on times of display of the frames of video includes compute differences in phase between received frames of video and displayed frames of video based on times of interrupt events for the received frames of video and displayed frames of video.

Example 7 includes the one or more computer-readable media of example 6, wherein adjust the clock rate further includes perform low-pass filtering on the differences in times.

Example 8 includes the one or more computer-readable media of example 5, wherein adjust the clock rate includes raise the clock rate if the differences in times indicate that that display of frames is falling behind receipt of frames.

Example 9 includes the one or more computer-readable media of example 5, wherein adjust the clock rate includes raise the clock rate if the differences in times indicate that that display of frames is getting ahead of receipt of frames.

Example 10 includes the one or more computer-readable media of example 5, wherein times include system clock timestamps.

Example 11 includes the one or more computer-readable media of any of examples 1-4, wherein the clock is part of a system on a chip.

Example 12 includes the one or more computer-readable media of example 11, wherein the clock includes a spread-spectrum clock.

Example 13 includes the one or more computer-readable media of example 12, wherein the clock is to operate as a phase-control element in a video synchronization phase-locked loop in addition to operating as a spread-spectrum clock.

Example 14 includes the one or more computer-readable media of any of examples 1-4, wherein the instructions are further to cause the computing device to determine whether the computing device has achieved phase lock.

Example 15 includes the one or more computer-readable media of example 14, wherein the instructions are further to determine that the computing device has not achieved phase lock and that the clock has been adjusted to a high or low limit and, based at least in part on determinations that the computing device has not achieved phase lock and that the clock has reached the high or low limit, cease or pause adjustment of the clock rate.

Example 16 includes an apparatus for presentation of synchronized video. The apparatus includes: one or more computing processors; a clock coupled to the one or more computing processors, the clock having a clock rate; a display module to operate on the one or more computing processors to display received frames of video based on the clock rate as controlled by the clock; and a clock control module configured to adjust the clock rate of the clock to synchronize display of the video with receipt of the frames of video.

Example 17 includes the apparatus of example 16, wherein the clock includes an oscillating clock and wherein adjust the clock rate includes adjust a rate of oscillation of the clock.

Example 18 includes the apparatus of example 17, wherein the clock includes a spread-spectrum clock having a frequency range and to provide spread-spectrum clock functions in addition to controlling display of the video, and wherein adjust the rate of oscillation includes adjust the rate of oscillation of the spread-spectrum clock over its frequency range.

Example 19 includes the apparatus of example 18, wherein the spread-spectrum clock is implemented in hardware and adjust the rate of oscillation of the spread-spectrum clock includes perform one or more software calls to set frequency control values in the hardware for the spread-spectrum clock.

Example 20 includes the apparatus of any of examples 16-19, wherein adjust the clock rate of the clock includes adjust the clock rate based on times of display of the frames of video.

Example 21 includes the apparatus of example 20, wherein adjust the clock rate based on times of display of the frames of video includes compute differences in phase between received frames of video and displayed frames of video based on times of interrupt events for the received frames of video and displayed frames of video.

Example 22 includes the apparatus of example 21, wherein adjust the clock rate further includes perform low-pass filtering on the differences in times.

Example 23 includes the apparatus of example 20, wherein adjust the clock rate includes raise the clock rate if the differences in times indicate that that display of frames is falling behind receipt of frames.

Example 24 includes the apparatus of example 20, wherein adjust the clock rate includes raise the clock rate if the differences in times indicate that that display of frames is getting ahead of receipt of frames.

Example 25 includes the apparatus of example 20, wherein times include system clock timestamps.

Example 26 includes the apparatus of any of examples 16-19, wherein the clock is part of a system on a chip.

Example 27 includes the apparatus of example 26, wherein the clock includes a spread-spectrum clock.

Example 28 includes the apparatus of example 27, wherein the clock is to operate as a phase-control element in a video synchronization phase-locked loop in addition to operating as a spread-spectrum clock.

Example 29 includes the apparatus of any of examples 16-19, wherein the clock control module is further to cause the computing device to determine whether the computing device has achieved phase lock.

Example 30 includes the apparatus of example 29, wherein the clock control module is further to determine that the computing device has not achieved phase lock and that the clock has been adjusted to a high or low limit and, based at least in part on determinations that the computing device has not achieved phase lock and that the clock has reached the high or low limit, cease or pause adjustment of the clock rate.

Example 31 includes a computer-implemented method for facilitating presentation of synchronized video. The method includes receiving, by a computing device, frames of video for display by the computing device and, during display of the video, adjusting, by the computing device, a clock rate for a clock of the computing device used to control display of the video to synchronize display of the video with receipt of the frames of video.

Example 32 includes the method of example 31, wherein the clock includes an oscillating clock and wherein adjusting the clock rate includes adjusting a rate of oscillation of the clock.

Example 33 includes the method of example 32, wherein the clock includes a spread-spectrum clock having a frequency range and to provide spread-spectrum clock functions in addition to controlling display of the video, and wherein adjusting the rate of oscillation includes adjusting the rate of oscillation of the spread-spectrum clock over its frequency range.

Example 34 includes the method of example 33, wherein the spread-spectrum clock is implemented in hardware and adjusting the rate of oscillation of the spread-spectrum clock includes performing one or more software calls to set frequency control values in the hardware for the spread-spectrum clock.

Example 35 includes the method of any of examples 31-34, wherein adjusting the clock rate of the clock includes adjusting the clock rate based on times of display of the frames of video.

Example 36 includes the method of example 35, wherein adjusting the clock rate based on times of display of the frames of video includes computing differences in phase between received frames of video and displayed frames of video based on times of interrupt events for the received frames of video and displayed frames of video.

Example 37 includes the method of example 36, wherein adjusting the clock rate further includes performing low-pass filtering on the differences in times.

Example 38 includes the method of example 35, wherein adjusting the clock rate includes raising the clock rate if the differences in times indicate that that display of frames is falling behind receipt of frames.

Example 39 includes the method of example 35, wherein adjusting the clock rate includes raising the clock rate if the differences in times indicate that that display of frames is getting ahead of receipt of frames.

Example 40 includes the method of example 35, wherein times include system clock timestamps.

Example 41 includes the method of any of examples 31-34, wherein the clock is part of a system on a chip.

Example 42 includes the method of example 41, wherein the clock includes a spread-spectrum clock.

Example 43 includes the method of example 42, wherein the clock is to operate as a phase-control element in a video synchronization phase-locked loop in addition to operating as a spread-spectrum clock.

Example 44 includes the method of any of examples 31-34, further including determining, by the computing device, whether the computing device has achieved phase lock.

Example 45 includes the method of example 44, further including: determining, by the computing device, that the computing device has not achieved phase lock and that the clock has been adjusted to a high or low limit; and based at least in part on determinations that the computing device has not achieved phase lock and that the clock has reached the high or low limit, ceasing or pausing, by the computing device, adjustment of the clock rate.

Example 46 includes an apparatus for facilitating presentation of synchronized video, the apparatus including: means for receiving frames of video for display by the computing device; and means for, during display of the video, adjusting a clock rate for a clock of the computing device used to control display of the video to synchronize display of the video with receipt of the frames of video.

Example 47 includes the apparatus of example 46, wherein the clock includes an oscillating clock and wherein means for adjusting the clock rate include means for adjusting a rate of oscillation of the clock.

Example 48 includes the apparatus of example 47, wherein the clock includes a spread-spectrum clock having a frequency range and to provide spread-spectrum clock functions in addition to controlling display of the video, and wherein means for adjusting the rate of oscillation include means for adjusting the rate of oscillation of the spread-spectrum clock over its frequency range.

Example 49 includes the apparatus of example 48, wherein the spread-spectrum clock is implemented in hardware and means for adjusting the rate of oscillation of the spread-spectrum clock include means for performing one or more software calls to set frequency control values in the hardware for the spread-spectrum clock.

Example 50 includes the apparatus of any of examples 46-49, wherein means for adjusting the clock rate of the clock include means for adjusting the clock rate based on times of display of the frames of video.

Example 51 includes the apparatus of example 50, wherein means for adjusting the clock rate based on times of display of the frames of video include means for computing differences in phase between received frames of video and displayed frames of video based on times of interrupt events for the received frames of video and displayed frames of video.

Example 52 includes the apparatus of example 51, wherein means for adjusting the clock rate further include means for performing low-pass filtering on the differences in times.

Example 53 includes the apparatus of example 50, wherein means for adjusting the clock rate include means for raising the clock rate if the differences in times indicate that that display of frames is falling behind receipt of frames.

Example 54 includes the apparatus of example 50, wherein means for adjusting the clock rate include means for raising the clock rate if the differences in times indicate that that display of frames is getting ahead of receipt of frames.

Example 55 includes the apparatus of example 50, wherein times include system clock timestamps.

Example 56 includes the apparatus of any of examples 46-49, wherein the clock is part of a system on a chip.

Example 57 includes the apparatus of example 56, wherein the clock includes a spread-spectrum clock.

Example 58 includes the apparatus of example 57, wherein the clock is to operate as a phase-control element in a video synchronization phase-locked loop in addition to operating as a spread-spectrum clock.

Example 59 includes the apparatus of any of examples 46-49, further including means for determining whether the computing device has achieved phase lock.

Example 60 includes the apparatus of example 59, further including: means for determining that the computing device has not achieved phase lock and that the clock has been adjusted to a high or low limit; and means for, based at least in part on determinations that the computing device has not achieved phase lock and that the clock has reached the high or low limit, ceasing or pausing adjustment of the clock rate.

Computer-readable media (including least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more computer-readable storage media comprising a plurality of instructions to cause a computing device, in response to execution of the instructions by the computing device, to:
receive frames of video for display by the computing device; and
during display of the video, adjust a clock rate for a clock of the computing device used to control display of the video to synchronize display of the video with receipt of the frames of video.

2. The one or more computer-readable media of claim 1, wherein the clock comprises an oscillating clock and wherein adjust the clock rate comprises adjust a rate of oscillation of the clock.

3. The one or more computer-readable media of claim 2, wherein the clock comprises a spread-spectrum clock having a frequency range and to provide spread-spectrum clock functions in addition to controlling display of the video, and wherein adjust the rate of oscillation comprises adjust the rate of oscillation of the spread-spectrum clock over its frequency range.

4. The one or more computer-readable media of claim 3, wherein the spread-spectrum clock is implemented in hardware and adjust the rate of oscillation of the spread-spectrum clock comprises perform one or more software calls to set frequency control values in the hardware for the spread-spectrum clock.

5. The one or more computer-readable media of claim 1, wherein adjust the clock rate for the clock comprises adjust the clock rate based on times of display of the frames of video.

6. The one or more computer-readable media of claim 5, wherein adjust the clock rate based on times of display of the frames of video comprises compute differences in phase between received frames of video and displayed frames of video based on times of interrupt events for the received frames of video and displayed frames of video.

7. The one or more computer-readable media of claim 6, wherein adjust the clock rate further comprises perform low-pass filtering on the differences in times.

8. The one or more computer-readable media of claim 5, wherein adjust the clock rate comprises raise the clock rate if the differences in times indicate that that display of frames is falling behind receipt of frames.

9. The one or more computer-readable media of claim 5, wherein adjust the clock rate comprises lower the clock rate if the differences in times indicate that that display of frames is getting ahead of receipt of frames.

10. The one or more computer-readable media of claim 5, wherein times comprise system clock timestamps.

11. The one or more computer-readable media of claim 1, wherein the clock is part of a system on a chip.

12. The one or more computer-readable media of claim 11, wherein the clock comprises a spread-spectrum clock.

13. The one or more computer-readable media of claim 12, wherein the clock is to operate as a phase-control element a video synchronization phase-locked loop in addition to operating as a spread-spectrum clock.

14. The one or more computer-readable media of claim 1, wherein the instructions are further to cause the computing device to determine whether the computing device has achieved phase lock.

15. The one or more computer-readable media of claim 14, wherein the instructions are further to:
determine that the computing device has not achieved phase lock and that the clock has been adjusted to a high or low limit; and
based at least in part on determinations that the computing device has not achieved phase lock and that the clock has reached the high or low limit, cease or pause adjustment of the clock rate.

16. An apparatus, comprising:
one or more computing processors;
a clock coupled to the one or more computing processors, the clock having a clock rate;
a display module to operate on the one or more computing processors to display received frames of video based on the clock rate as controlled by the clock; and
a clock control module configured to adjust the clock rate of the clock to synchronize display of the video with receipt of the frames of video.

17. The apparatus of claim 16, wherein the clock comprises a spread-spectrum clock having a frequency range and to provide spread-spectrum clock functions in addition to controlling display of the video, and wherein adjust the rate of the clock comprises adjust a rate of oscillation of the spread-spectrum clock over its frequency range.

18. The apparatus of claim 16, wherein adjust the clock rate of the clock comprises adjust the clock rate based on times of display of the frames of video.

19. The apparatus of claim 18, wherein adjust the clock rate based on times of display of the frames of video comprises compute differences in phase between received frames of video and displayed frames of video based on times of interrupt events for the received frames of video and displayed frames of video.

20. The apparatus of claim 19, wherein the clock is to operate as a phase-control element in a video synchronization phase-locked loop in addition to operating as a spread-spectrum clock.

21. A computer-implemented method, comprising:
receiving, by a computing device, frames of video for display by the computing device; and
during display of the video, adjusting, by the computing device, a clock rate for a clock of the computing device used to control display of the video to synchronize display of the video with receipt of the frames of video.

22. The method of claim 21, wherein the clock comprises a spread-spectrum clock having a frequency range and to provide spread-spectrum clock functions in addition to controlling display of the video, and wherein adjusting the rate of the clock comprises adjusting a rate of oscillation of the spread-spectrum clock over its frequency range.

23. The method of claim 21, wherein adjusting the clock rate of the clock comprises adjusting the clock rate based on times of display of the frames of video.

24. The method of claim 23, wherein adjusting the clock rate based on times of display of the frames of video comprises computing differences in phase between received frames of video and displayed frames of video based on times of interrupt events for the received frames of video and displayed frames of video.

25. The method of claim 24, wherein the clock is to operate as a phase-control element a video synchronization phase-locked loop in addition to operating as a spread-spectrum clock.
